(19) United States
(12) Patent Application Publication
(10) Pub. No.: US 2007/0226656 A1
(43) Pub. Date: Sep. 27, 2007

(54) Graphic User Interface, a System, a Method and a Computer Program for Interacting With a User

(75) Inventor: Paul Zwart, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,643

(22) PCT Filed: Apr. 28, 2005
(86) PCT No.: PCT/IB05/51385

§ 371 Date: Nov. 3, 2006

(30) Foreign Application Priority Data
May 3, 2004 (EP) 04101886.2

(51) Int. Cl. G06F 3/033

(52) U.S. Cl. 715/856

(57) ABSTRACT

The invention relates to a graphic user interface comprising an interaction area for interacting with a user, said graphic user interface being arranged to position a cursor within the interaction area, wherein a precision interaction point is assigned to the cursor in order to enable said positioning, said precision interaction point being defined as a preset fraction of a distance between a user definable stationary interaction point 11 and a user definable movable interaction point 13. Preferably, both points 11, 13 are indicated to the user during the procedure of setting the precision interaction point 17, as well as the actual position of the precision interaction point 17 for a visual feed back. In case the user is not satisfied with the current position of the precision interaction point 17, he further moves the movable interaction point 13 thus repositioning the precision interaction point until his satisfaction. Usually, for user's convenience, the value of the fraction is set to 0.5 yielding the precision interaction point at the middle between the points 11, 13. Alternatively, the fraction can be set to a value less than 0.5 to position the precision interaction point 17 closer to the stationary interaction point 11. Still alternatively, the fraction can be set at a value greater than 0.5, but less than 1.0 to position the precision interaction point closer to the movable interaction point 13. Still alternatively, the value of the fraction is set to a value greater than two, yielding a substantial magnification of the distance b. Preferably, the precision interaction point is positioned on the line 15 connecting points 11, 13. Alternatively, the position of the precision interaction point can be defined at an intersection of a perpendicular set at the fraction distance with a reference object. The invention further relates to a system comprising a customizable device and a graphic user interface. The invention still further relates to a method of defining the precision interaction point.

The invention relates to a graphic user interface comprising an interaction area for interacting with a user, said graphic user interface being arranged to position a cursor within the interaction area.

The invention further relates to a system comprising a customizable device and a graphic user interface.

The invention still further relates to a method for defining a precision interaction point. The invention still further relates to a computer program for positioning a movable cursor on a display means.

An embodiment of a graphic user interface as is set forth in the opening paragraph is known from U.S. Pat. No. 5,872,559. The known graphic user interface comprises an interaction area, like a touchpad of a suitable touch screen, arranged to enable an interaction with a user. For purposes of such an interaction, the user has to place a suitable pointing device on an area of the touchpad, thereby activating a pre-programmed response of the graphic user interface. In a particular embodiment of the known graphic user interface, the touchpad is arranged to follow a movement of the pointing device, it being a user's finger. For this purpose a suitable operating system of a computer associated with the known graphic user interface is arranged first to detect touch screen pixel coordinates under the user's moving finger and in response thereto to redefine new areas of the touchpad being touch screen areas under the finger at its new location on the touch screen. The area of the user's finger is in fact a cursor with increased dimensions. When the new touchpad is defined, the user can interact with the graphic user interface by placing the finger substantially fully over the area of the touchpad.

It is a disadvantage of the known graphic user interface that in order to enable an interaction with the user, the graphic user interface requires a pixel area on the touch screen to be activated by a pointing device. In case a finger is selected as the pointing device, the number of maximum possible actuatable items on the screen decreases due to the large area of resulting cursor. Also, when activating an item using a finger, a viewing of the screen information is obstructed by the finger, thus leading to possibly incorrect placing of an interaction point. This problem is particularly pronounced for drawing applications.

It is an object of the invention to provide a graphic user interface whereby the user is enabled to position the interaction point with high precision.

To this end, in the graphic user interface according to the invention a precision interaction point is assigned to the cursor in order to enable said positioning, said precision interaction point being defined at a preset fraction of a distance between a user definable stationary interaction point and a user definable movable interaction point.

The technical measure of the invention is based on the insight that it is possible to create a pointing system, where the actual size of the cursor or the pointing device is irrelevant to an operation of a cursor setting on the screen. Thus, it is sufficient to define two points on the screen and a fraction of the distance between them whereto the precision interaction point is to be placed. As the second point is movable, it is also not important where to place the first interaction point, as the resulting position of the precision interaction point can easily be corrected interactively and in real time, by appropriately repositioning the movable interaction point. Advantageously, the target area whereto the precision interaction point is to be set is not obstructed by the stationary and movable interaction points. It is further of no importance which pointing device is selected for interaction with the graphic user interface. For small cursors, like a conventional arrow or a cross-bar, a pixel position corresponding to the resulting screen position of the cursor can be assigned to a top of the arrow, or to a geometrical center of the figure, or to any other coordinate related to a cursor representation on the screen. With the graphic user interface according to the invention the accuracy of placing of even a miniature cursor, like a conventional arrow, is substantially increased, as the user does not have to observe the arrow's top and to point it to an object he wishes to select, it being sufficient to place the cursor somewhere near the targeted object or a screen area. For cursors of sufficient dimensions, like a finger top for touch screens, it is sufficient to define a single reference pixel corresponding, for example, to a center of the finger top area. Other possibilities of defining the net cursor positions lie within the technical skill of the person skilled in the art, and are contemplated as well. The graphic user interface according to the invention is particularly advantageous for applications using touch screens and cursors of substantial dimensions, as fingers, pens, light beams, etc., as the cursor is not obstructing the screen area the user is interacting with. It is particularly advantageous for small screens, like those of mobile electronic apparata, including personal computers, mobile phones and electronic agendas. For stationary devices, which are usually provided with a display of a substantial dimension, an amount of selectable items to be placed within the interaction area of such display can be increased, as the selection of the item is enabled by a single pixel placed somewhere on the area of the item. The item may be a touchpad, an object on a city map, a tiny icon, etc. The item may also be a part of the image conceived to be edited by a user, for example an image arranged for drawing an area, or for placing reference points, etc. An accuracy of handling these features is advantageously improved using the graphic user interface according to the invention. Various possibilities of setting the fraction of the distance between the stationary interaction point and the movable interaction point are possible. It is possible to set the fraction to a number less than unity, in this case the precision interaction point will be positioned between the stationary interaction point and the movable interaction point. In this embodiment it is possible to define the fraction at 0.5 the distance, thus ensuring the precision interaction point being exactly at the middle. This setting is advantageous for selection operations, whereby the user sets the stationary interaction point nearby the object he wishes to select and then places the movable interaction point at an opposite side of the object. This feature works particularly well for objects of a few pixels. For the drawing operation, it might be advantageous to set the fraction much less than the unity, for example, in the order of 0.1. The resulting precision interaction point will lie close to the stationary interaction point, it being used as a first guess. Alternatively, it is possible to set the fraction to a number greater than unity. In this case the precision interaction point will lie outside the line connecting two user-defined interaction points. It must be noted, that the precision interaction point may alternatively be positioned outside the line connecting the stationary interaction point and the movable interaction point. In this case, for example, an additional reference object is used, the position of the precision interaction point being defined as an intersection point between the reference object and a perpendicular to the line connecting the stationary interaction point and the movable interaction point.

In an embodiment of the graphic user interface according to the invention an actual position of the precision interaction point is being displayed to the user continuously during a manipulation of the movable interaction point. It must be noted that for practicing the invention it is in principle sufficient to a-priori disclose to the user the fraction of the distance, which is then used for setting the precision interaction point in a single step. However, in some applications, like drawing, it is advantageous to allow a continuous viewing of the placement of the precision interaction point thus allowing for a real-time correction of this positioning. In case the user is not satisfied with the placing of the precision interaction point, he can displace the movable interaction point thus redefining the position of the precision interaction point to his satisfaction.

In a further embodiment of the graphic user interface according to the invention, the graphic user interface is further arranged to display an image and to enable a definition of a contour within an image area by means of a plurality of interconnected precision interaction points. The current embodiment of the graphic user interface according to the invention is particularly useful in the field of handling medical data, whereby it is required to draw with high precision a region of interest on, for example, an image of a patient. In particular, when such drawing is carried out intra-operatively, the quality of the definition of the region of interest is not decreased by reduced finger's sensitivity due to sterile gloves the operator has to wear.

In a still further embodiment of the graphic user interface according to the invention a plurality of precision interaction points is definable, the graphic user interface being further arranged to enable a geometric measurement between at least two precision interaction points. It is found to be particularly advantageous to provide precision interaction points for applications aimed at carrying out high precision planometry measurements on images. Various planometry measurements are envisages, including but not limited to a distance, an angle, a matching factor between objects defined by the precision interaction points, etc. This feature is of particular advantage for carrying out measurements on image data for pre-operative analysis, like a planning of an implant.

In a system according to the invention a setting of the device is being customized in accordance with a selection carried out using the precision interaction point. Various computerized systems are known in the art of computer added control. The system according to the invention is advantageously provided with a graphic user interface arranged to position the cursor using the precision interaction point, including all advantages of operating with the precision interaction point as are described above with reference to the graphic user interface.

In an embodiment of the system according to the invention, the customizable device comprises a radiation emitter comprising a control means arranged to determine a spatial range of emitted radiation in accordance with a setting of the control means, wherein said setting is definable by a contour defined using a plurality of interconnected precision interaction points on an image data, said image data being provided on the graphic user interface.

An embodiment of a system arranged to define a spatial range of emitted radiation in accordance with a contour drawn on the image data, is known from US 2002/0051516 A1 of the same applicant, wherein an X-ray apparatus is contemplated. The known X-ray apparatus is arranged to set collimators defining a resulting X-ray beam in accordance with a region of interest drawn using a graphic user interface showing an actual transmission image. In case some areas on the image are to be shielded, the operator draws a contour on the actual image, the control means of the known X-ray apparatus is arranged to deduce the collimator setting in accordance with the drawn region of interest using a predefined algorithm. The problem of the known customizable device is that the accuracy of the collimator setting is inevitably dependent on the accuracy of the contour drawing. In case the contour is to be drawn under an intra-operative setting, the accuracy decreases strongly, as the operator usually wears sterile gloves and the touch screen in protected with a layer of sterile plastic. When drawing using fingers, the accuracy of the resulting cursor placing thus reduces due to the fact that at least two layers of material is present between the pointing device (finger in glove or pen in cover) and the touch screen. Additionally, the pointing device obstructs the image area directly under it reducing the accuracy of placing the cursor.

According to the technical measure of the invention all these drawbacks of the prior art are mitigated, as the placing of the cursor is enabled in accordance with the,precision interaction point, advantages thereof being explained earlier with reference to the graphic user interface.

A method of defining a precision interaction point according to the invention comprises the steps of:
providing a display means arranged to display a movable cursor;
defining a first interaction point on the display means using the movable cursor;
calculating a first pixel position corresponding to the first interaction point;
defining a second interaction point on the display means using the movable cursor;
calculating a second pixel position corresponding to the second interaction point;
calculating a pixel position of the precision interaction point from the first pixel position and the second pixel position;
displaying the precision interaction point at the calculated pixel position.

The computer program according to the invention computer program contains instructions for:
operating the movable cursor on a display means;
calculating a first pixel position corresponding to a first interaction point definable on the display means using the movable cursor;
calculating a second pixel position corresponding to a second interaction point definable on the display means using the movable cursor;
calculating a precision pixel position for the cursor from the first pixel position and the second pixel position;
positioning the cursor at the precision pixel position.

It is found to be advantageous to provide a dedicated computer program arranged to position the movable cursor on the display means using the precision pixel position. The computer program according to the invention can be loaded into suitable computer means as an upgrade of conventional cursor positioning software. Preferably, the computer program according to the invention is stored on a portable media, like a CD-ROM. Alternatively, the computer program according to the invention may be downloadable from an internet site.

These and other aspects of the invention will be discussed in further detail with reference to figures, wherein like reference signs represent like items.

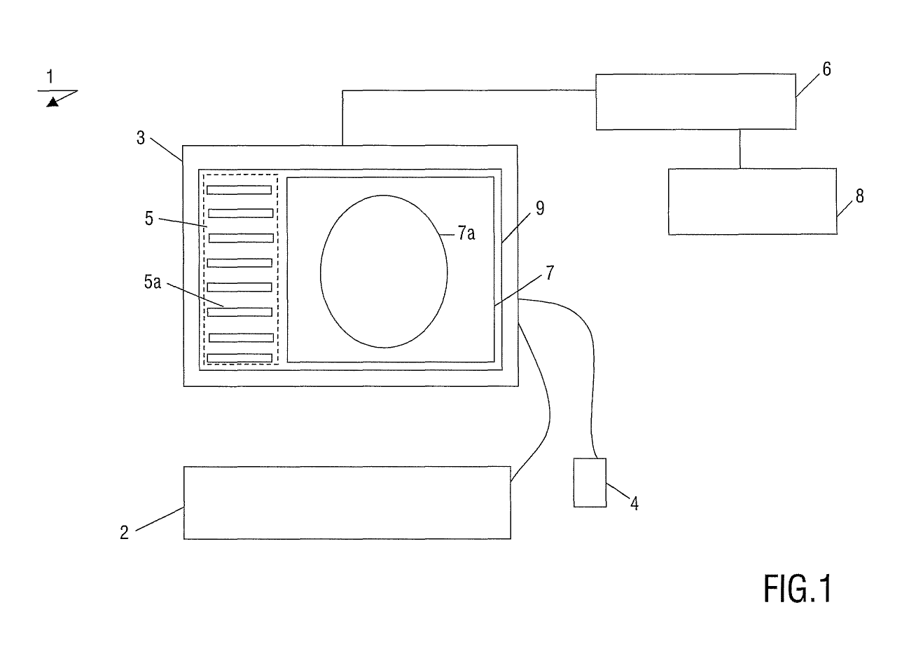

FIG. 1 presents a schematic view of a graphic user interface according to the invention.

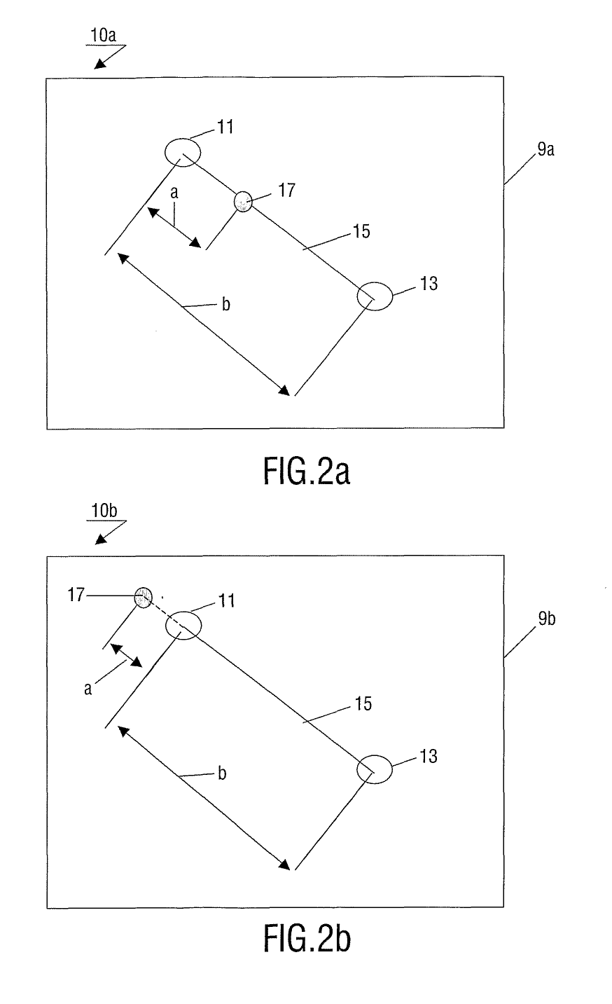

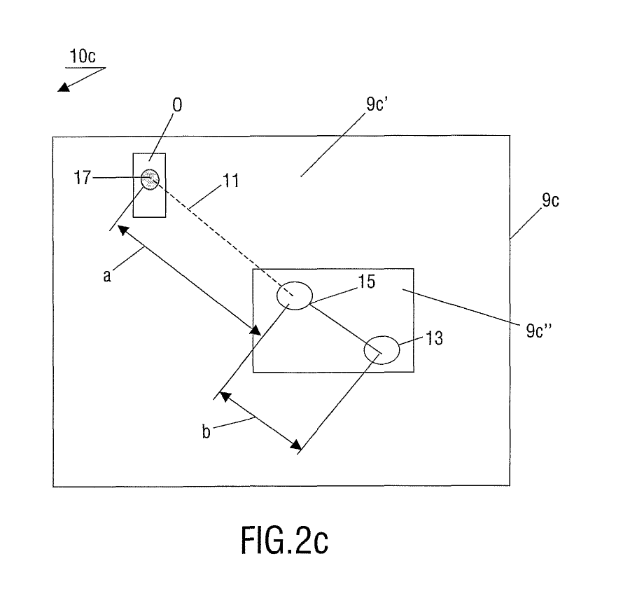

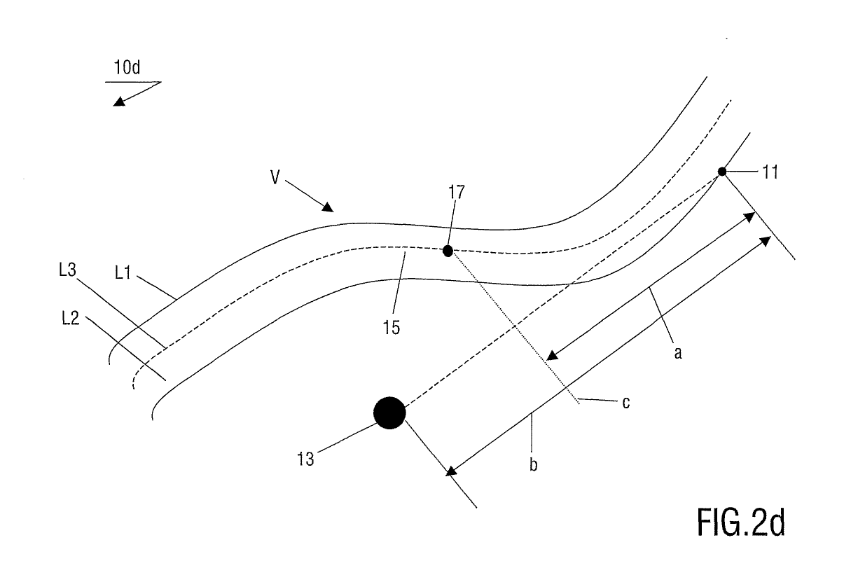

FIG. 2a presents in a schematic way a first embodiment of a placing of the precision interaction point.

FIG. 2b presents in a schematic way a second embodiment of a placing of the precision interaction point.

FIG. 2c presents in a schematic way a third embodiment of a placing of the precision interaction point.

FIG. 2d presents in a schematic way a third embodiment of a placing of the precision interaction point.

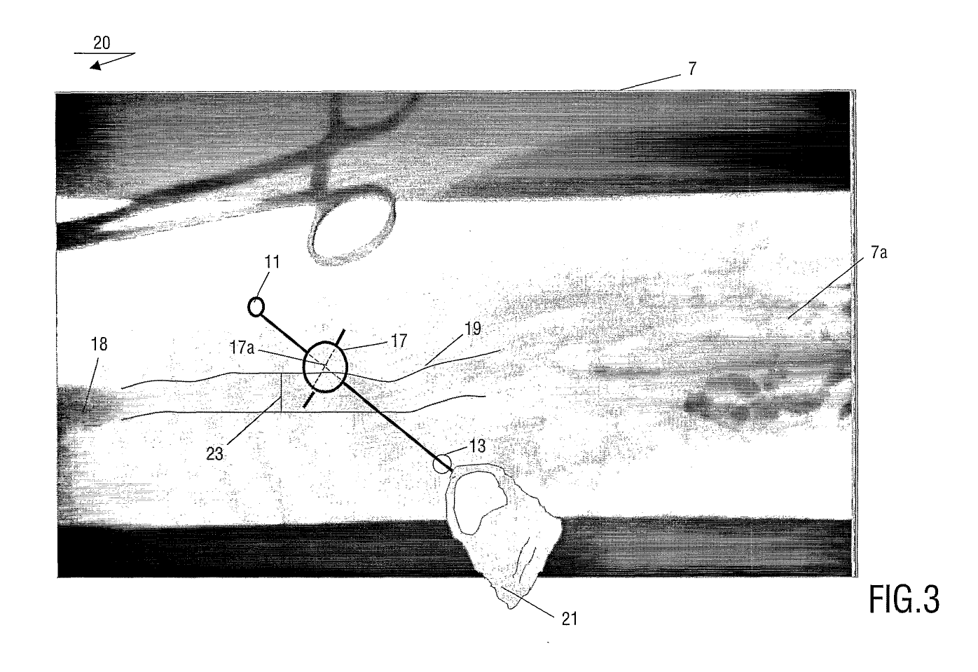

FIG. 3 presents in a schematic way an embodiment of a drawing application with the graphic user interface according to the invention.

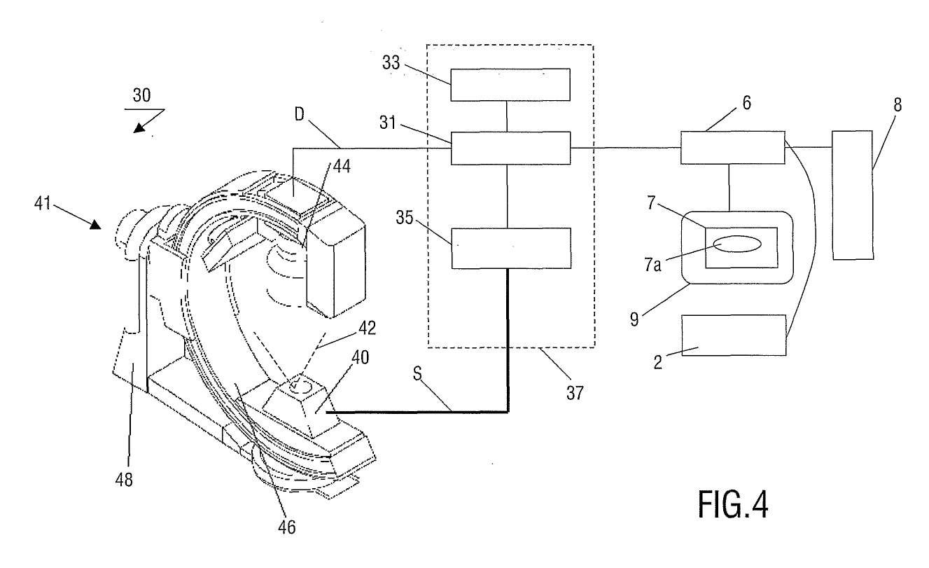

FIG. 4 presents in a schematic way an embodiment of a system according to the invention.

FIG. 1 presents a schematic view of a graphic user interface according to the invention. The graphic user interface 9 is a suitable computer program arranged to enable an interaction with a user. The computer program is preferably stored as an executable code in a database 8 accessible by a processor 6. The graphic user interface 9 can be visualized on a suitable display means 3. An example of the suitable display means is a monitor or a touch screen. The graphic user interface 9 is advantageously provided with actuatable items of the type 5a, which are shown in an interactive window 5. It must be noted that an absolute dimension of the items of the type 5a can be as small as a few pixels. The items 5a are arranged to activate a certain function of the processor 6, for example to run a computer code corresponding to a certain pre-programmed functionality of the processor. Those skilled in the art will appreciate that it is possible to practice a plurality of functionalities without departing from the present invention. In order to enable the interaction with the user, the graphic user interface 9 is provided with a movable cursor (not shown) which is manipulated by the user in order to activate the desired item. Because the positioning of the cursor in the graphic user interface according to the invention is enabled using the precision interaction point, the absolute size of the items 5a can be minimized, thus allowing to present as many items 5a as possible on the screen. Additionally, the graphic user interface 9 may comprise a graphics window 7 enabling a user to draw an object 7a within it. According to the invention, also the drawing operation is carried out using the precision interaction point, thus increasing the accuracy of the drawing operation. The procedure of setting the precision interaction point will be discussed in more detail with reference to FIGS. 2a to 2d. In order to manipulate the cursor, the graphic user interface can be provided with cursor positioning means, like a conventional mouse device 4, or a keyboard 2. In case the display means 3 is a touch screen, the user may use a special pointing device (not shown), or his or her fingers for positioning the cursor. Due to the fact that the final cursor position is set in accordance with the precision interaction point, the user is enabled to set the cursor with a high precision, whereby a target area is not obstructed by the pointing device or by the finger.

FIG. 2a presents in a schematic way a first embodiment of a placing of the precision interaction point. For this purpose an example using a finger-tip operated touch screen is shown. The graphic user interface 9a enables the user to set a precision interaction point 17 using a user-definable stationary interaction point 11 and a user-definable movable interaction point 13, the precision interaction point being set on a line 15 running through the stationary interaction point 11 and the movable interaction point 13 at a pre-determined fraction a of a distance b between those points 11, 13. Therefore, a substantial area of a finger tip is reduced to a single pixel cursor, thus improving the positioning accuracy. Preferably, both points 11, 13 are indicated to the user during the procedure of setting the precision interaction point 17, as well as the actual position of the precision interaction point 17 for a visual feed back. In case the user is not satisfied with the current position of the precision interaction point 17, he further moves the movable interaction point 13 thus repositioning the precision interaction point until his satisfaction. Usually, for user's convenience, the value of the fraction is set to 0.5 yielding the precision interaction point at the middle between the points 11, 13. Alternatively, the fraction can be set to a value less than 0.5 to position the precision interaction point 17 closer to the stationary interaction point 11. Still alternatively, the fraction can be set at a value greater than 0.5, but less than 1.0 to position the precision interaction point closer to the movable interaction point 13.

FIG. 2b presents in a schematic way a second embodiment of a placing of the precision interaction point. In this particular embodiment of the graphic user interface 9b according to the invention the value of the fraction is set to a value larger than 1, resulting in the placement of the precision interaction point 17 outside the line 15 between the stationary interaction point 11 and the movable interaction point 13.

FIG. 2c presents in a schematic way a third embodiment of a placing of the precision interaction point. The graphic user interface 9c in this example comprises a touch-sensitive area 9c″ and a non touch-sensitive area 9c′. By setting the value of the fraction to a value greater than 1, for example to a value between 2 and 5, preferably 2.5, it is possible to seed the precision interaction point beyond the touch-sensitive area. According to this feature it is possible to reach selectable objects O positioned in the non touch-sensitive area of the graphic user interface. As a provision of a touch sensitive area requires a sophisticated technology, thus increasing the price of such screen, according to the technical measure of the present embodiment, it is possible to minimize the necessary number of touch-sensitive areas on the screen, yet leaving the possibility to seen the interaction point anywhere on the graphic user interface.

FIG. 2d presents in a schematic way a third embodiment of a placing of the precision interaction point. In this case the position of the precision interaction point 17 is defined by an intersection between a pre-defined curve L3 and a fraction line c propagating perpendicularly to the line 15 between the stationary interaction point 11 and the movable interaction point 13. This embodiment is advantageously applicable in drawing applications, whereby it is required to seed an interaction point on a curved line, for example on a middle line of a blood vessel V. In this case a middle line L3 of the vessel V is defined, preferably using a suitable segmentation technique. In this embodiment, first a stationary interaction point 11 is positioned somewhere on a vessel. Then, a movable interaction point 13 is positioned, the resulting precision interaction point is geometrically obtained at an intersection between the fraction line c and the reference line L3. Preferably, before placing the precision interaction point 17, the graphic user interface feeds back its current position to the user. The user may reposition the precision interaction point, if necessary.

FIG. 3 presents in a schematic way an embodiment of a drawing application with the graphic user interface according to the invention. Also this embodiment is illustrated for a situation where the user is working with his finger 21, interacting with a touch screen. An example of a drawing application is editing an image, for example a medical image 7a. Other embodiments of a suitable drawing application, including, but not limited to a technical drawing or an editing of a digital photograph are contemplated as well. For a medical image 7a it might be desirable to draw a contour of a target area or an organ under investigation. In this example a vessel 18 is used. In order to draw an alignment of the vessel 18, the user first seeds the stationary interaction point 11 with his finger 21. A procedure of assigning a screen pixel to an interaction point is known per se and it will not be explained here in detail. Next, as soon as the user defines the movable interaction point 13, the precision interaction point 17 is being displayed to the user. In this example a graphic representation of the precision interaction point is exaggerated for clarity purposes. Accordingly, the graphic representation may comprise a cross-wire 17a to indicate a position of the pixel corresponding to the actual position of the precision interaction point to the user. In case the user is not satisfied with the current position of the precision interaction point, he may reposition the finger 21, until he is satisfied. The corresponding position of the precision interaction point is updated in real time. When operating with precision interaction points, it is possible to align a structure with high precision. An example of such a structure is given by a drawing of a vessel wall 19. When a plurality of precision interaction points 17 are defined within the graphics window 7, it is further possible to carry out planometric measurements using these points. The resulting measurements have an increased accuracy. In this example a measurement of a diameter 23 of the vessel 18 is shown, using the alignment lines 19.

FIG. 4 presents in a schematic way an embodiment of a system according to the invention. In this particular embodiment an X-ray device 41 is selected as the customizable device according to the invention. The X-ray device 41 is arranged to emit a beam 42 of X-rays emanating from the X-ray source 40. The beam 42 is cut off using a set of collimators (not shown). A patient (not shown) to be examined is positioned between the X-ray source 40 and the X-ray detector 44. To enable an oblique viewing the X-ray source 40 and the X-ray detector 44 are rotatably mounted using the gantry 46, which is rotated with respect to the stand 48. The patient data D are provided to the control means 37, which is arranged to reconstruct image data which are to be forwarded to a viewing means 6. The viewing means 6 comprise a graphic user interface 9, arranged to visualize the resulting image data 7 and to enable a user interaction with it in order to modify a setting of the X-ray device in accordance with a user's selection. A plurality of possibilities is envisaged. First, the user can activate a control panel (not shown) and select an alteration of an electronic setting of the device 41 using suitable control buttons. For example, a gantry stand and/or a stand of a patient support table can be changed in accordance with a user's desire. Next to this, the system according to the invention is arranged to modify the device setting in accordance with a contour 7a drawn by the user on the image 7. The contour 7a is drawn using the precision interaction points explained with reference to FIGS. 2a to 2d. When the contour drawing is finalized, the control means 37 translates the image pixel positions of the contour into a collimator setting, preferably using a pre-defined look-up table 33. When the corresponding collimator setting is determined, a suitable control signal delivery means 35 applies the control signal S to motors driving the collimator blocks or collimator lamella in order to conform the resulting X-ray beam 42 to the contour 7a automatically. Preferably, the contour 7a determines the region of interest conceived to be subjected to the X-ray beam 42. In case the X-ray source 40 is not arranged with a multi-leaf collimator enabling figure fields, the computing means 31 calculates a best fit to the contour 7a using a rectangular or a square field. When the setting of the X-ray device is customized, the procedure of the patient handling carries on and a new image data D is fed to the viewing means 6. It must be understood that in spite of the fact that a very specific embodiment is shown in this figure, the person skilled in the art will easily understand that a plurality of modifications of this embodiment are possible without departing the teaching of the invention. For example, the X-ray unit can be substituted by a magnetic resonance imaging apparatus, whereby the user is enabled to customize settings of the apparatus using the graphic user interface operating using the precision interaction points. As with the X-ray unit, the user may define a region of interest using a plurality of precision interaction points, the setting of the gradient coils and the excitation pulses being set accordingly to enable a viewing of the thus defined region of interest. In case the system according to the invention operates using an ultra-sound imaging apparatus, the frequency and/or the number of activated transducers in an array may be customized in accordance with a selection or a contour defined by the user using the precision interaction points of the graphic user interface.

1. A graphic user interface (9) comprising an interaction area (5, 7) for interacting with a user, said graphic user interface being arranged to position a cursor within the interaction area (5, 7), wherein a precision interaction point (17) is assigned to the cursor in order to enable said positioning, said precision interaction point being defined at a preset fraction (a) of a distance (b) between a user definable stationary interaction point (11) and a user definable movable interaction point (13).

2. A graphic user interface according to claim 1, wherein an actual position of the precision interaction point (17) is being displayed to the user continuously during a manipulation of the movable interaction point (13).

3. A graphic user interface according to claim 2, wherein said graphic user interface is further arranged to display an image (7a) and to enable a definition of a contour (19) within an image area by means of a plurality of interconnected precision interaction points (17).

4. A graphic user interface according to claim 2, wherein a plurality of precision interaction points (17) is definable, the graphic user interface being further arranged to enable a geometric measurement (23) between at least two precision interaction points (19).

5. A graphic user interface according to claim 1, wherein said graphic user interface is arranged to operate a computer code (8) upon an event of positioning of the cursor on an area of a control button (5a) assigned to said computer code.

6. A system (30) comprising a customizable device (41) and a graphic user interface (9) according to claim 1, wherein a setting of the device (41) is being customized in accordance with a selection carried out using the precision interaction point.

7. A system according to claim 6, when dependent on claim 3, wherein the customizable device comprises a radiation emitter (40) comprising a control means (37) arranged to determine a spatial range (42) of emitted radiation in accordance with a setting (S) of the control means, wherein said setting is definable by said contour (7a).

8. A method of defining a precision interaction point, said method comprising the steps of:
providing a display means (9) arranged to display a movable cursor,
defining a first interaction point (11) on the display means using the movable cursor;
calculating a first pixel position corresponding to the first interaction point;
defining a second interaction point (13) on the display means using the movable cursor;
calculating a second pixel position corresponding to the second interaction point;
calculating a pixel position (17) of the precision interaction point from the first pixel position (11) and the second pixel position (13);
displaying the precision interaction point (17) at the calculated pixel position.

9. A method according to claim 8, wherein the first interaction point is stationary, the second interaction point (13) is movable, said method comprising a further step of displaying the pixel position (17) continuously.

10. A computer program for positioning a movable cursor on a display means, said computer program containing instructions for:
operating the movable cursor on a display means;
calculating a first pixel position corresponding to a first interaction point definable on the display means using the movable cursor;
calculating a second pixel position corresponding to a second interaction point definable on the display means using the movable cursor;
calculating a precision pixel position for the cursor from the first pixel position and the second pixel position;
positioning the cursor at the precision pixel position.
